(19) United States
(12) Patent Application Publication
(10) Pub. No.: US 2010/0083914 A1
(43) Pub. Date: Apr. 8, 2010

(54) ANTI-IMPACT OCULAR PROTECTOR FOR HORSES

(75) Inventor: EDUARDO ALBERTO AMAYA, CAPITAL FEDERAL (AR)

Correspondence Address: LONDA, BRUCE S.;NORRIS MCLAUGHLIN & MARCUS, PA, 875 THIRD AVE, 8TH FLOOR, NEW YORK, NY, 10022, US

(73) Assignee: FOXPRO, BUENOS AIRES (AR)

(21) Appl. No.: 12/571,900

(22) Filed: Oct. 1, 2009

(30) Foreign Application Priority Data
Oct. 2, 2008 (AR) 080104305

(51) Int. Cl. A01K 29/00

(52) U.S. Cl. 119/850

(57) ABSTRACT

It is an ocular device for protecting horses eyes made of impact-proof polycarbonate with a warped structure perfectly shaped to be placed as a pair of glasses that will fit with the bones that form the eye socket of the horse. The glasses are constituted by a frame with devices to keep it in the right position, it surrounds the eyes of the horse without bothering its peripheral vision and protecting it from impacts that could seriously damage it. The ocular protector presents a convex concave structure, provided with means for its correct fixing, adjusting it over the eyeball of the horse. This ocular device also have the option of lenses and forehead protection for racing and horses to transport.

This invention is linked with elements for the ocular protection in general, and, it refers in particular to an ocular protecting device whose main purpose is that it has been designed to be applied to horses.

Another purpose of this invention is to provide a simple arrangement that has been perfectly shaped to be placed as a pair of glasses that fit with the bones that form the eye socket. The glasses are constituted by a frame with devices to keep it in the right position. This frame has a warped structure that surrounds the eyes of the horse without bothering its vision and protecting it from impacts that could seriously damage it.

One more purpose of this invention is the new making of the protecting elements that have fixing systems to make them perfectly fit in the required places to achieve the best protection.

Furthermore, the choice of the elements for the making of the invention that offers the best results is described below.

The main purpose of this invention is to avoid the consequences of an ocular traumatism that could affect the eyes of the horse due to an accident during its transport in trucks, trailers or the appropriate means of transport.

In the particular case of horses used for sports such as polo, polo cross and pato, the ball as well as the mallet are the direct causes of this kind of accident apart from the ones mentioned above that are very frequent in these animals due to the transportation of the horses from its place of residence to the places where they play.

The arrangement of the invention has been studied so that it adapts in the best way to the head of the animal so that the different risky alternatives that take place in these kinds of sports that are played at high displacement speeds and frequent collisions don't allow detachments or changes in its correct position, or, what could be worse, the direct impact of the ball or the mallet on any of the eyes, during a sports competition.

Another advantage is the materials used to make the protector and the means that support it that form a halter that is fixed to head of the animal.

Among the possible materials required for the making of the device, the best option was polycarbonate polymers, whether transparent or coloured. For the fixing devices, an elastic band, plastics integrated by the same material forming a pair of glasses and supplementary strips that can be covered by leather such as sole or a similar material.

As you can notice in the figures illustrating this document, in some of the cases, the protecting ocular frames are assembled individually in the fixing elements, or they can also form a basic integral element with fixing accessories to the head and the muzzle of the horse.

Among the reasons that took the petitioner to the creation of this invention, it can be added that his personal experience as a veterinarian specialised in clinic of sport horses and orthopaedic surgery, and as professional, instructor and trainer of polo horses, he has had excessive consultations and contact with horses that have suffered accidents that involved the vision of the horse. A lot of these horses couldn't continue performing this activity, especially in Polo as the rules of the game establish that “one-eyed horses are not allowed to play”. Therefore, apart from the permanent damage for the animal that produces, as a consequence, the loss of a trained animal, you will suffer the economic cost involved in this situation.

It is also important to say that in the above mentioned case about polo, the danger is greater when a penalty shot is made for the players can be positioned in front of the goal mouth to prevent the ball from entering the in goal.

The advantages of the invention have been mentioned and it is important to add the reduced cost of the protector compared to the protection it offers to the horse.

### BRIEF DESCRIPTION OF DRAWINGS

The schematic figures attached to this legal-technical description state that:

FIG. 1 shows an internal perspective of one of the protectors separated form its fixing harness.

FIG. 2 is an external perspective of one of the protectors alone.

FIG. 3 consists of a lateral perspective of one of the protectors.

FIG. 4 represents a part of the head of a horse with the ocular protector on, with a lateral vision.

FIG. 5 consists of a frontal vision of the protector according to the representation in FIG. 1.

FIG. 6 shows a mounting harness of the protectors in FIGS. 1 and 2.

FIG. 7 consists of a different support to fix the protector of the previous figures.

FIG. 8 consists of another option for an ocular integral protector.

In the figures described above the same references indicate similar o corresponding parts.

FIG. 9 shows a lateral perspective of one of the protectors with lenses separated form its fixing harness.

FIG. 10 consists of an external perspective of one of the protectors with the hold to fix the lenses.

FIGS. 1, 2 and 3 of the anti-impact ocular protector provide different positions to offer a whole comprehension of the purpose of this description. It is formed by a frame -1-, preferably moulded in a plastic resistant to impacts whose frame has been made in a particular rolling warped shape and with a thickness adequate to the minimum resistance it needs.

It is shown in the figures that it basically presents a concave-convex structure so that its concave part corresponds to the interior of the device that faces the eyeball of the horse and the convex part corresponds to the outside.

This interior warped shape matches with the bone and muscular structure of the head of the horse in the area around the eyes. This is why both protectors are symmetric.

Each individual protector takes the shape that best suits the periorbita of the horse that is formed by an internal bone layer, the Zygomatic process of the temporal bone, the zygomatic process of the temporal bone and the supraorbital process of the frontal bone. An intermediate muscular layer represented by the orbicular muscle of the eye and an external layer of the skin.

The outside warped shape joins with the interior part but, at the same time, it offers wide prominences -2- and -3- softly rounded that form the prominent areas protecting the animal from external attacks.

The frame -1- has a particular oblong opening -4- that takes into account the natural ocular movements of the animal so that it does not bother its peripheral vision.

Said frame -1- counts in this specific case with two quadrangular gaps -5- and -6- for the bands or strips used to keep the protectors fixed in the correct position.

FIGS. 4 and 5 show both protectors are inter-linked by means of a leather strip -7- whose ends pass through the above mentioned gaps -6-. They count with devices to adjust their separation and which allow them to adopt the correct position between the eyes. The position is individually adapted to each head of the horse that needs it and to the gap -5- that links them with the strips -8- that surround the head behind the ears and in the low part -9- of the nod.

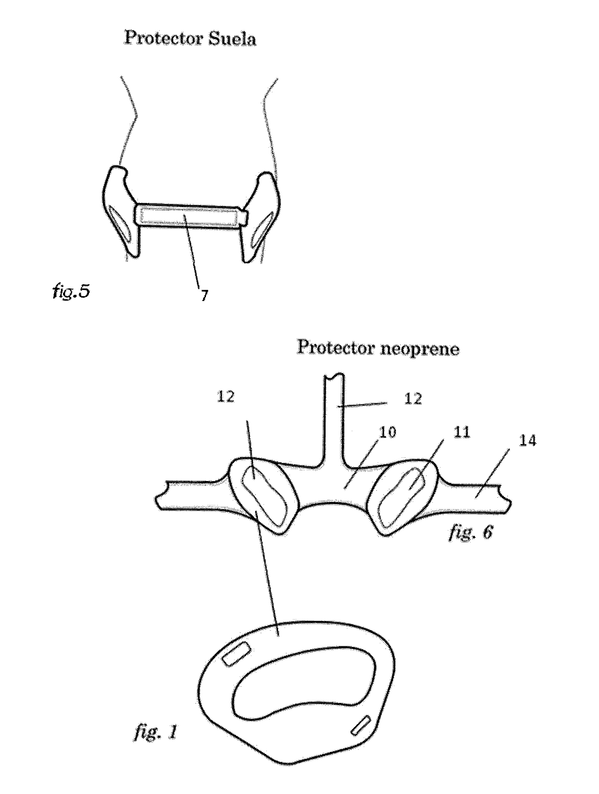

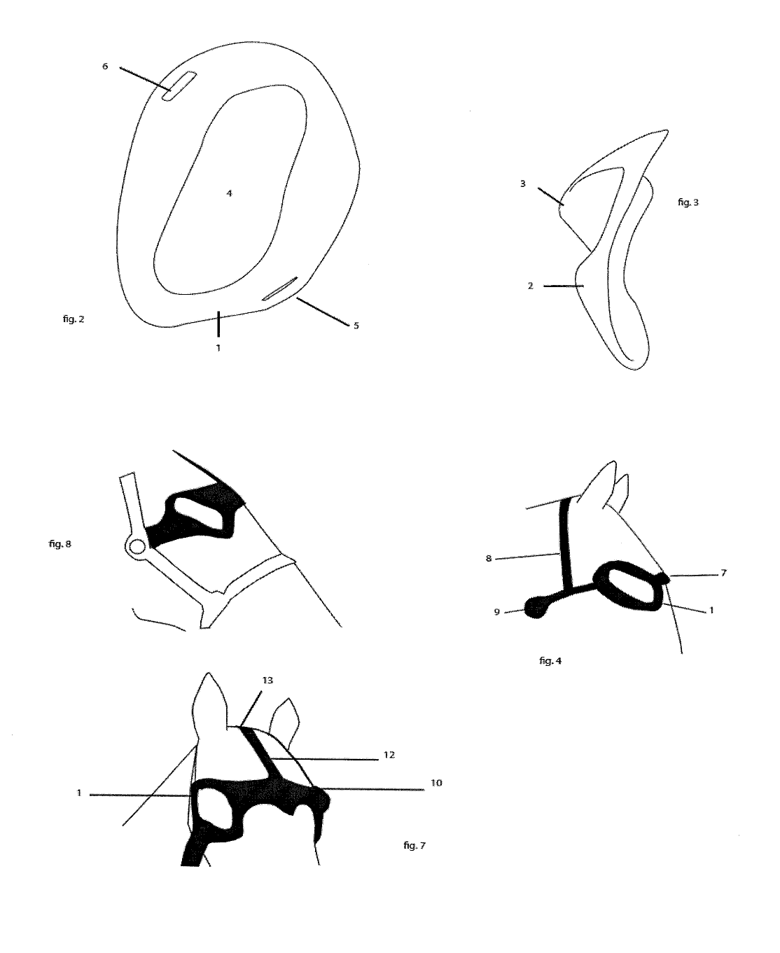

FIG. 6 shows an integral support structure made of an elastic material like neoprene -10- in which the holes -11- designed for the each of the protectors to fit in have been made -1-.

FIGS. 5 and 6 are linked by both arrows. They link the neoprene and sole with the protector in FIG. 1.

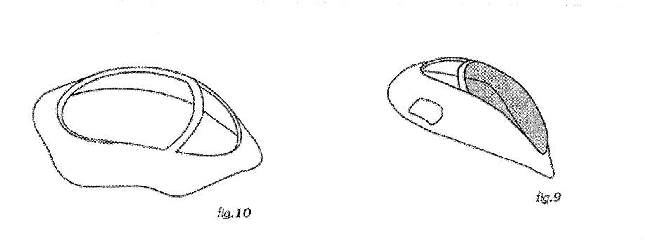

FIG. 7 shows the part of the head of the horse with the integral mounting support on, illustrated in the previous FIG. 6 that shows the individual anti-impact protectors integrated as “remove and place” -1-. The support counts with a central strip -12- on the upper edge that passes through the forehead of the animal and joins with the other strip -13- and -8- that passes through the head behind the ears and the lateral extensions -14- are oriented to the jaw of the animal.

FIG. 8 shows a similar figure to the above mentioned but it integrally integrates each protector in the correct position.

It can be noticed in the figures that each protector does not have sharp edges so that the finished device has soft curvatures.

The ocular protector can be fixed in the correct position by means of an elastic transparent band that comes from each of the protectors and it joins in the lower part, behind the jaw and in the upper part, in the forehead between the two protectors and the front part of the head, as shown.

As an alternative, the ocular protector can be coloured in its higher and lower part, to avoid the use of the wool muzzle in the case of horses that have to jump shadows, stripes and black dots and also for those who are scared of the ball in the case of Polo.

It is important to mention that said ocular protector can have anti-insect elements or lens and any type of grid added.

### Operation:

Once the different components of the invention have been established, developed to explain their nature, the description is completed below, with the operational and functional relation of its pars and the result they offer.

The preferable material for the making of the ocular protectors is polycarbonate.

According to the resistance tables of the polycarbonate, it is able to suffer impacts of up to 115 km/ph. Polycarbonate ca be used transparent or coloured, as a pair of goggles on the bones above mentioned that compose the eye socket of the horse.

The possibility of protection offered by this arrangement can be also used in other sports o disciplines as a means for preventing ocular traumatisms as well as other secondary factors that could affect horses during their transportation. This is explained below.

As for the operational relation of the elements of the invention, it is important t o add more information due to their evident functional qualities.

As a conclusion, it arises from the experimental tests made on the material mentioned that it has demonstrated a capacity of absorption of impacts at the stated speed in the tables, thus eliminating a 100% of the injuries. This means an important reduction of the causes that make animals useless for sports, extending significantly the usefulness of the horses and reducing the costs of medical treatments and insurance.

The possibilities of making the invention that lead to its creation and the way it works have been stated. The document is completed with the summary of the invention included in the claims that are stated below.

Having described and stated the nature of the invention, its scope and the way it can be put into practice in its main idea, it is declared as an invention and exclusive property as follows:

1. An anti-impact ocular protector for horses used on the eyes of the animal, wherein each of the devices placed on each eye of the horse consists of a frame preferably moulded in a plastic resistant to impacts that has been made with a particular rolling warped shape and with a thickness adequate to the minimum resistance it needs. It basically presents a concave-convex structure so that its concave part corresponds to the interior of the device that faces the eyeball of the horse and the convex part corresponds to the outside. This interior warped shape matches with the bone and muscular structure of the head of the horse in the area around the eyes. This is why both protectors are going to be symmetric. The outside warped shape joins with the interior part but, at the same time, it offers wide prominences placed in the arch of the eye and below it. The prominences are softly rounded and the form the prominent areas protecting the animal from external attacks. Said frame has a particular oblong opening that takes into account the natural ocular movements of the animal so that it does not bother its peripheral vision. Said individual protectors are provided with devices to keep them fixed on the socket of the eyes f the horse.

2. An anti-impact ocular protector for horses according to claim 1, wherein each individual protector adopting the shape that best suits the periorbita of the horse that is formed by an internal bone layer, the the Zygomatic process of the temporal bone, the zygomatic process of the temporal bone and the supraorbital process of the frontal bone. An intermediate muscular layer represented by the orbicular muscle of the eye and an external layer of the skin.

3. An anti-impact ocular protector for horses according to claim 1, wherein the frame that also counts with two quadrangular gaps for the bands or strips used to keep the protectors fixed in the correct position.

4. An anti-impact ocular protector for horses according to claim 1, wherein both protectors inter-linked by means of a leather strip whose ends pass through the above mentioned gaps. They count with devices to adjust their separation and which allow them to adopt the correct position between the eyes. The position is individually adopted to each head of the horse that needs it and to the outside gaps that links them with the strips that surround the head behind the ears and in the low part of the nod.

5. An anti-impact ocular protector for horses according to claim 1, wherein the devices to keep it fixed on the periorbita of the horse, of both individual orbital protectors consist of an integral support structure made of an elastic material like neoprene in which the holes designed for the each of the protectors to fit in have been made.

6. An anti-impact ocular protector for horses according to claim 1, wherein the devices to keep it fixed on the periorbita of the horse that consist of an integral support structure made of an elastic material like neoprene that counts with a central strip on the superior edge that passes through the forehead of the animal and joins with the other strip and that passes through the head behind the ears and the lateral extensions are oriented to the jaw of the animal.

7. An anti-impact ocular protector for horses according to claim 1, wherein the devices to keep it fixed on the periorbita of the horse that consist of an integral support structure that integrally integrates each protector in the correct position.

8. An anti-impact ocular protector for horses according to claim 1, wherein the devices used to keep the protectors fixed and their elastic nature.
